(19) United States
(12) Patent Application Publication
(10) Pub. No.: US 2011/0181124 A1
(43) Pub. Date: Jul. 28, 2011

(54) BREAKER AND POWER MONITORING SYSTEM

(75) Inventor: Shinichi Uesaka, Kanagawa (JP)

(73) Assignee: SONY CORPORATION, Tokyo (JP)

(21) Appl. No.: 13/006,661

(22) Filed: Jan. 14, 2011

(30) Foreign Application Priority Data
Jan. 22, 2010 (JP) P2010-011739

(51) Int. Cl. H01H 83/00

(52) U.S. Cl. 307/113

(57) ABSTRACT

A breaker is provided including a plurality of branch breakers. The plurality of branch breakers each include: a current measuring section configured to measure a current flowing through an internal power line; a radio communicating section configured to transmit a measured value of the current measuring section to an information processing device by radio; and a power supply section configured to supply power to the radio communicating section.

### CROSS REFERENCES TO RELATED APPLICATIONS

The present application claims priority to Japanese Patent Application No. JP 2010-011739 filed on Jan. 22, 2010, the entire contents of which is hereby incorporated by reference.

### BACKGROUND

The present disclosure relates to a breaker and a power monitoring system that can monitor power consumed by an electronic device installed in an area such as a household or a factory.

Recently, development aimed at a low-carbon society has been actively pursued. For this aim, it is necessary to reduce power used in households, factories, offices and the like. While progress has been made in reducing power used in factories, offices and the like, progress has not been made very much in reducing power used in ordinary households. One of reasons for this is that residents of a household do not correctly know power use conditions within the household. When power use conditions within a household can be monitored easily, it is possible to give a motivation to reduce unnecessary power consumption. This is an effect produced by “visualizing” consumed power. Further, an amount of power usage can be optimized through combination with a power controlling system and a database.

In the past, a breaker that measures a current value within the breaker in a noncontact manner and which allows the measured value to be read on the outside has been proposed (see Japanese Patent Laid-Open No. Hei 07-280846, hereinafter referred to as Patent Document 1). In addition, a device having a measuring sensor fixed to wiring outside a breaker and measuring the value of current flowing through the breaker has been put to practical use.

### SUMMARY

The breaker described in Patent Document 1 simply reads the value of current flowing within the breaker. Thus, the breaker cannot be used to monitor power demand within a household at all times and optimize the power demand. Further, in the case of the device having the measuring sensor fixed to the power line outside the breaker, work for fixing the measuring sensor is complicated.

It is therefore desirable to provide a breaker and a power monitoring system that can measure current used by one or a plurality of electronic devices and which can contribute to reduction in power usage by presenting the measured value to a consumer.

According to an embodiment, there is provided a breaker including a plurality of branch breakers, the plurality of branch breakers each including: a current measuring section configured to measure a current flowing through an internal power line; a radio communicating section configured to transmit a measured value of the current measuring section to an information processing device by radio; and a power supply section configured to supply power to the radio communicating section.

Preferably, the power supply section is one of a battery and a capacitor.

Preferably, the power supply section is a noncontact power supply device.

Preferably, the current measuring section measures the current in a noncontact manner.

Preferably, the plurality of branch breakers are each identified by an identifier.

According to an embodiment, there is provided a power monitoring system including: a breaker including a plurality of branch breakers, the plurality of branch breakers each including a current measuring section configured to measure a current flowing through an internal power line, a first radio communicating section configured to transmit a measured value of the current measuring section by radio, and a power supply section configured to supply power to the first radio communicating section; a second radio communicating section configured to communicate with the first radio communicating section; and an information processing device for processing the measured value received via the second radio communicating section.

Preferably, the information processing device is connected to the Internet.

According to an embodiment, it is possible to monitor power use conditions of electronic devices connected to the respective branch breakers, and reduce power consumption in a household or the like by presenting a measured amount of power usage to a consumer.

Additional features and advantages are described herein, and will be apparent from the following Detailed Description and the figures.

### BRIEF DESCRIPTION OF THE FIGURES

FIG. 1 is a block diagram of a first embodiment;

FIG. 2 is a block diagram of an example of a breaker in the first embodiment; and

FIG. 3 is a schematic diagram for use in explaining the first embodiment.

### DETAILED DESCRIPTION

Embodiments will hereinafter be described.

### 1. First Embodiment

Power Monitoring System

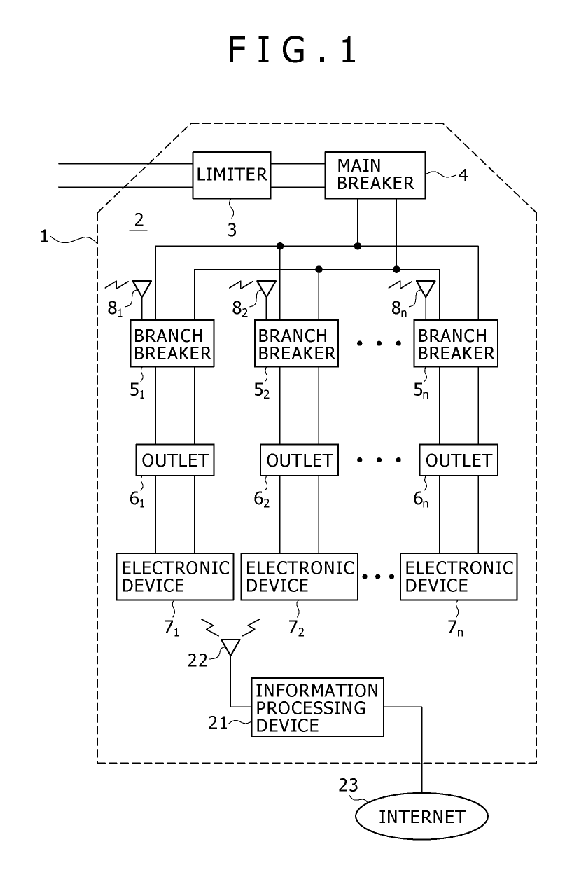

A power monitoring system according to an embodiment will be described with reference to FIG. 1. Power generated in a power plant of a power supplier is connected to a limiter 3 of a breaker (referred to also as a distribution switchboard, a circuit breaker or the like) 2 in an area shown enclosed by a broken line, which area is for example a household 1, via a transmission network and a distribution network not shown in FIG. 1. A single-phase three-wire system is often used in practice for a service wire from a nearby power transformer to the household 1. In FIG. 1, however, a single-phase two-wire system is used for simplicity. The limiter 3 is referred to also as a service breaker. The limiter 3 is automatically tripped to stop the supply of the power when a current larger than a current specified in a contract between an electric utility and the household 1 flows.

A main breaker 4 is connected to the limiter 3. The main breaker 4 has a leakage interrupting function. The main breaker 4 is tripped when a leak occurs or a total of flowing currents becomes larger than a specified value. A plurality of (n) branch breakers 5₁, 5₂, . . . , and 5ₙ are connected to the main breaker 4. The branch breakers 5₁ to 5ₙ are tripped when a current larger than an allowable current of 20A, for example, flows or an overcurrent flows due to a short circuit.

The circuits of the limiter 3, the main breaker 4, and the branch breakers 5₁ to 5ₙ are interrupted as a result of a bimetal being bent by heat when an overcurrent flows. Some perform interrupting operation by an electromagnetic system without depending on heat generated by an overcurrent. When the interrupting operation has been performed, the circuits can be restored by turning off the power supply switch of a causal electronic device and operating a lever of the breakers.

Outlets 6₁, 6₂, . . . , and 6ₙ in the household 1, for example, are connected to the branch breakers 5₁ to 5ₙ, and electronic devices 7₁ to 7ₙ are connected to the outlets 6₁ to 6ₙ, respectively. Examples of the electronic devices 7₁ to 7ₙ are air conditioners, refrigerators, lighting fixtures, and washing machines, television receivers.

In practice, it is not often that the branch breakers 5₁ to 5ₙ are each connected with one outlet as in the constitution of FIG. 1, but the branch breakers 5₁ to 5ₙ are provided for each set of a plurality of outlets or electronic devices in an area such as a room or the like. Further, the branch breakers 5₁ to 5ₙ may be provided so as to correspond to kinds of electronic devices 7₁ to 7ₙ . For example, the branch breakers 5₁ to 5ₙ are provided so as to correspond to air conditioners, lighting fixtures, outlets and the like. Further, without limitation to electronic devices, terminals for charging a battery for a house or a vehicle-mounted battery, for example, may be connected to the breaker 2.

As will be described later, the branch breakers 5₁ to 5ₙ each have functions of measuring a current flowing through a power line of the branch breaker, obtaining an integrated value of the current, and measuring power usage from a detected voltage value and the integrated current value. The branch breakers 5₁ to 5ₙ have a function of then transmitting the measured values by radio. Incidentally, the branch breakers 5₁ to 5ₙ may have a current measuring function and transmit the value of a measured current so that power is calculated on the side of an information processing device.

Antennas 8₁ to 8ₙ are provided to the branch breakers 5₁ to 5ₙ to transmit the measured values by radio. In the example shown in FIG. 1, all the branch breakers have the function of measuring power usage. However, only part of the branch breakers may have the power measuring function. For example, a branch breaker connected with an electronic device of low power consumption may not have the power measuring function.

An information processing device 21 that performs radio communication with the branch breakers 5₁ to 5ₙ is provided within the household 1. An ordinary microcomputer used in a household can be used as the information processing device 21. Specifically, the information processing device 21 includes an arithmetic section, a memory, a display section, and an input device. For example an application program for processing a received measured value of power of each branch breaker is installed onto the microcomputer. The information processing device 21 has an antenna 22 for radio communication. Further, the information processing device 21 can communicate with a terminal device, a site and the like on an external network, for example the Internet 23.

A radio wave, for example, is used as a medium of radio communication between the branch breakers 5₁ to 5ₙ and the information processing device 21. Bluetooth or ZigBee can be used as a communication system. The Bluetooth system is applied to multimedia communication, and allows communication through a one-to-many connection. ZigBee uses a physical layer of IEEE (Institute of Electrical and Electronics Engineers) 802.15.4. IEEE802.15.4 is the name of a short-range wireless network standard referred to as a PAN (Personal Area Network) or a W (Wireless) PAN. Further, a wireless LAN (Local Area Network) system may also be used.

The information processing device 21 uses a measured value (digital data) of current flowing through each branch breaker to perform processing such for example as generating a display screen for displaying a present current value for each of the branch breakers 5₁ to 5ₙ, calculating a cumulative amount of power for a predetermined period, for example one month for each of the branch breakers 5₁ to Sₙ, or calculating an electricity charge. In this case, the measured value is sampled at appropriate intervals of a few seconds and processed. Alternatively, a value obtained by sampling the measured value transmitted by each of the branch breakers 5₁ to 5ₙ may be used. A result of processing of the information processing device 21 is displayed on the screen of a display device provided to the information processing device 21. The processing result may be displayed on the display section of a television receiving device in the household. A user (resident of the household 1) viewing the display can be informed of power use conditions.

The information processing device 21 has a predetermined URL (Uniform Resource Locator) on the Internet 23. Thus, the processing result of the information processing device 21 can be viewed from a terminal device of the user via the Internet 23. Further, when an abnormality such that one of the branch breakers 5₁ to 5ₙ is tripped due to an overcurrent resulting from a short circuit occurs, the information processing device 21 generates an alarm warning of the occurrence of the abnormality to notify the occurrence of the abnormality to the terminal of the user via the Internet 23.

Branch Breaker

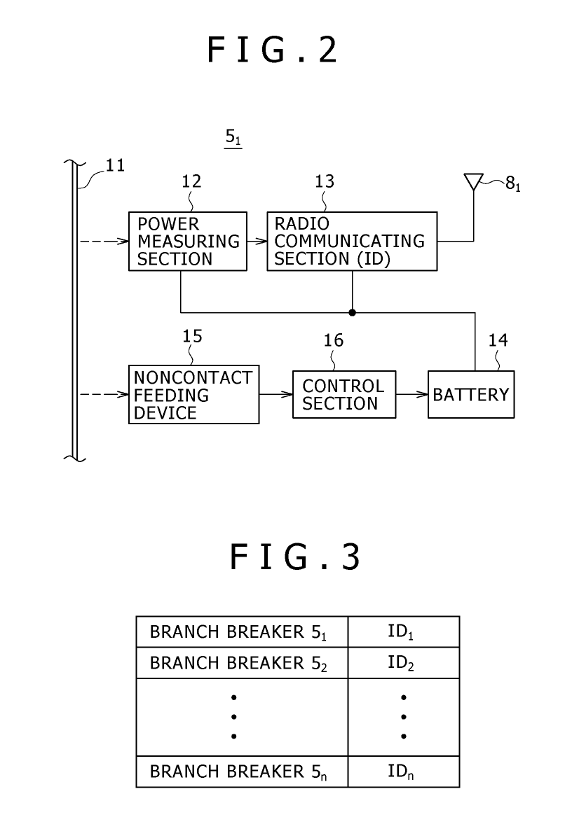

An example of the branch breaker 5₁ will be described with reference to FIG. 2. Incidentally, the other branch breakers 5₂ to 5ₙ have a similar constitution to that of the branch breaker 5₁. Though omitted in FIG. 2, each branch breaker is configured such that the circuit of the branch breaker is interrupted when an overcurrent flows, as in an existing device. Further, when the interrupting operation has been performed, the branch breaker can be restored by turning off the power supply switch of a causal electronic device and operating the lever of the breaker. A power measuring section 12 measures a current flowing through a power line 11 within the branch breaker 5₁, and measures power from the measured value of the current. The power line 11 passes through a constitution of a noncontact system, for example a ring-shaped coil, and the current flowing through the power line 11 is measured from a current electromagnetically induced in the ring-shaped coil. A constitution that measures power from an integrated value of the measured current and a voltage value can be used. A specified value or a measured value is used as the voltage value. Further, the current may be measured by using a sensor for detecting a magnetic flux originating from the power line 11.

The measured value of the power measuring section 12 is supplied to a radio communicating section 13. The radio communicating section 13 performs two-way radio communication with the information processing device 21. An identifier unique to the branch breaker 5₁ (which identifier will hereinafter be referred to as an ID as appropriate) is stored in a nonvolatile memory of the radio communicating section 13. The ID is added to the measured value when the measured value is transmitted to the information processing device 21. As shown in FIG. 3, unique identifiers ID₁ to IDₙ are assigned to the respective branch breakers 5₁ to 5ₙ. For example, the identifiers ID₁ to IDₙ serve also as an ID for identifying a terminal in a radio communication system. Thus, the information processing device 21 can determine which branch breaker transmitted a measured value on the basis of the ID included in received data.

In the Bluetooth system, for example, the information processing device 21 is a master (parent machine), and the information processing device 21 can communicate with a maximum of seven slaves (child machines) (radio communicating sections of the branch breakers 5₁ to 5ₙ) that can be connected simultaneously within a radius of 10 m of the information processing device 21. When the IEEE802.15.4 system is used, pairing is first performed between the information processing device 21 and the radio communicating sections 13 of the branch breakers 5₁ to 5ₙ.

Power necessary for the operation of the power measuring section 12 and the radio communicating section 13 is supplied from a battery 14. The battery 14 is for example a lithium-ion secondary battery. The battery 14 is charged by power generated by a noncontact feeding device 15. Without limitation to the noncontact feeding device 15, the battery 14 may be charged by power generated by power generation using renewable energy. Power generation using renewable energy includes photovoltaic power generation, wind power generation, and biomass power generation.

A noncontact feeding device using electromagnetic induction can be used as an example of the noncontact feeding device 15. Specifically, a transformer is formed by electromagnetically coupling a primary coil provided in a power transmitting device with a secondary coil provided in a power receiving device. An alternating voltage of a predetermined frequency is supplied to the primary coil. Direct-current power is generated by rectifying the alternating voltage induced in the secondary coil. The direct-current power is supplied to a control section 16.

The control section 16 performs control necessary to charge the battery 14 by the direct-current power from the noncontact feeding device 15. In the case of a lithium-ion secondary battery, for example, the control section 16 performs charging by a CV (constant voltage)/CI (constant current) system. Charging operation is not performed when the battery 14 is in a range of usable voltage. Further, the noncontact feeding device 15 may use power induced from the power line 11 as transmitting power. Further, without limitation to the noncontact feeding device, the current flowing through the power line 11 may be branched to form a power source.

In the foregoing first embodiment, the branch breakers 5₁ to 5ₙ of the breaker 2 each measure a current flowing therein, whereby power being used is measured in each of the branch breakers in real time. A measured value obtained by sampling the measured power as required is transmitted to the information processing device 21 by radio communication. The information processing device 21 processes the measured value received by the information processing device 21, whereby present consumed power is obtained for each of the branch breakers.

The obtained consumed power of each of the branch breakers is displayed on the display section of the information processing device 21 or the like, and is presented to the user. The user can obtain information on actual consumed power by looking at the present consumed power of each of the branch breakers. The user can consequently try to save power or take a measure to prevent the tripping of a breaker, knowing beforehand a fear of the breaker being tripped.

### 2. Examples of Modification

Not only the Internet but also a portable telephone network may be used for connection to the outside. Further, as a power supply for a branch breaker, a capacitor may be used in place of a battery. Further, the present embodiments are applicable to not only households but also power monitors for offices in buildings, factories, and the like.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A breaker comprising a plurality of branch breakers, the branch breakers each including:
a current measuring section configured to measure a current flowing through an internal power line;
a radio communicating section configured to transmit a measured value of said current measuring section to an information processing device by radio; and
a power supply section configured to supply power to said radio communicating section.

2. The breaker according to claim 1,
wherein said power supply section is one of a battery and a capacitor.

3. The breaker according to claim 1,
wherein said power supply section is a noncontact power supply device.

4. The breaker according to claim 1,
wherein said current measuring section measures the current in a noncontact manner.

5. The breaker according to claim 1,
wherein said plurality of branch breakers are each identified by an identifier.

6. A power monitoring system comprising:
a breaker including
a plurality of branch breakers, the plurality of branch breakers each including
a current measuring section configured to measure a current flowing through an internal power line,
a first radio communicating section configured to transmit a measured value of said current measuring section by radio, and
a power supply section configured to supply power to said first radio communicating section;
a second radio communicating section configured to communicate with said first radio communicating section; and
an information processing device for processing said measured value received via said second radio communicating section.

7. The power monitoring system according to claim 6,
wherein said information processing device is connected to the Internet.

8. A breaker comprising a plurality of branch breakers, the plurality of branch breakers each including:
current measuring means for measuring a current flowing through an internal power line;
radio communicating means for transmitting a measured value of said current measuring means to an information processing device by radio; and
power supply means for supplying power to said radio communicating means.
